(19) United States
(12) Patent Application Publication
(10) Pub. No.: US 2021/0039972 A1
(43) Pub. Date: Feb. 11, 2021

(54) CONTROL SYSTEM AND CONTROL METHOD

(71) Applicant: Yokogawa Electric Corporation, Tokyo (JP)

(72) Inventors: Mika KAWATA, Tokyo (JP); Jun AOKI, Tokyo (JP); Mitsunori FUKUZAWA, Tokyo (JP)

(21) Appl. No.: 16/983,512

(22) Filed: Aug. 3, 2020

(30) Foreign Application Priority Data
Aug. 7, 2019 (JP) 2019-145668

(51) Int. Cl. C02F 3/00; C02F 3/30

(52) U.S. Cl. CPC C02F 3/006; C02F 3/302; C02F 3/308; C02F 2209/003; C02F 2209/38; C02F 2209/11; C02F 2101/34; C02F 2209/18; C02F 2209/08; C02F 2209/40; C02F 2209/22; C02F 2209/14; C02F 2209/44; C02F 2209/16

(57) ABSTRACT

A calculator calculates, using a model of a process relating to water treatment, an output variable including an effluent water quality indicating a quality of effluent water flowing out of the process based on input variables including an influent water quality indicating a quality of influent water flowing into the process and a manipulated value for the process. The calculator acquires a combination satisfying a predetermined constraint condition among combinations of the manipulated value and the output variable. A controller controls the process based on the manipulated value in the combination acquired by the calculator. A calibrator regenerates a parameter representing a characteristic of the model at regular intervals, and replaces the parameter of the model with the regenerated parameter when the effluent water quality calculated according to the regenerated parameter is closer to a measured value of the effluent water quality than the effluent water quality calculated according to the parameter before regeneration.

### BACKGROUND

### Technical Fields

The present invention relates to a control system and a control method.

Priority is claimed on Japanese Patent Application No. 2019-145668, filed on Aug. 7, 2019, the contents of which are incorporated herein by reference.

### Related Art

In a process of wastewater treatment as an example of water treatment, a treatment of purifying wastewater in influent water and discharging effluent water of a predetermined water quality is performed, for example, using a method such as an anaerobic-anoxic-aerobic (Anaerobic-Anoxic-Oxic (A2O)) method. Control of such a process relating to water treatment using a model has been proposed to increase the efficiency of the process. Japanese Unexamined Patent Application Publication No. 2017-91056 discloses a technology that automatically generates a model for optimization calculation that represents the characteristics of a plant including a wastewater treatment plant.

Incidentally, environments of the wastewater treatment plant change according to changes in the seasons and surrounding environments, deterioration of equipment over time, or the like. In order to maintain the accuracy of predicting the quality of effluent water, it is desirable that coefficients (parameters) of characteristic equations of the model be adjusted according to changes in the environments. However, in a technology disclosed in Japanese Unexamined Patent Application Publication No. 2019-13858, it is up to the user to determine when to adjust the model and whether to use the adjusted model. Therefore, the model does not always follow changes in the environments of the treatment process.

### SUMMARY

The present invention has been made to solve the above problems and provides a control system which may include: a calculator configured to calculate, using a model of a process relating to water treatment, an output variable including an effluent water quality indicating a quality of effluent water flowing out of the process based on input variables including an influent water quality indicating a quality of influent water flowing into the process and a manipulated value for the process, the calculator being configured to acquire a combination satisfying a predetermined constraint condition among combinations of the manipulated value and the output variable; a controller configured to control the process based on the manipulated value in the combination acquired by the calculator; and a calibrator configured to regenerate a parameter representing a characteristic of the model at regular intervals and to replace the parameter of the model with the regenerated parameter when the effluent water quality calculated according to the regenerated parameter is closer to a measured value of the effluent water quality than the effluent water quality calculated according to the parameter before regeneration.

Further features and aspects of the present disclosure will become apparent from the following detailed description of exemplary embodiments with reference to the attached drawings.

### BRIEF DESCRIPTION OF THE DRAWINGS

FIG. 1 is a block diagram showing an example of a general wastewater treatment system.

FIG. 2 is a block diagram showing a configuration of a control system according to the present embodiment.

FIG. 3 is a diagram simply showing a model according to the present embodiment.

FIG. 4 is a flowchart showing an example of processing of a control calculator according to the present embodiment.

FIG. 5 is a flowchart showing a process of correcting an airflow rate (step S17 in FIG. 4) according to the present embodiment.

FIG. 6 is a flowchart showing an example of a process of adjusting a parameter set of a model according to the present embodiment.

FIG. 7 is a diagram for explaining examples of the estimated values of the effluent water quality and the degrees of matching when parameter sets before and after adjustment are used.

FIG. 8 is a flowchart showing an example of a process of adjusting lag times according to the present embodiment.

FIG. 9 is a diagram simply showing a model in a sludge treatment process.

FIG. 10 is a diagram simply showing a model in a treatment process for digestion gas power generation.

### DETAILED DESCRIPTION OF THE EMBODIMENTS

The embodiments of the present invention will be now described herein with reference to illustrative preferred embodiments. Those skilled in the art will recognize that many alternative preferred embodiments can be accomplished using the teaching of the present invention and that the present invention is not limited to the preferred embodiments illustrated herein for explanatory purposes.

An aspect of the present invention is to provide a control system and a control method capable of making a model follow changes in the environments of a treatment process.

Embodiments of a control system and a data processing method according to the present invention will be described below with reference to the drawings. In the present embodiment, wastewater treatment is illustrated as an example of water treatment.

### [Overview]

Embodiments of the present invention enable a model to follow changes in the environments of the treatment process. Using a model that follows changes in the environments, it is possible to maintain the prediction accuracy of the effluent water quality and to appropriately control the treatment process. According to another aspect of the present invention, it is possible to use a model that reduces power cost while following changes in the environments of the treatment process.

For example, the model for optimization calculation disclosed in Japanese Unexamined Patent Application Publication No. 2017-91056 is used as a process model of the wastewater treatment system. Using the model, it is possible to calculate a predicted value of the quality of effluent water corresponding to the quality of influent water and the influent amount thereof.

Environments of the wastewater treatment plant change according to changes in the seasons and surrounding environments, deterioration of equipment over time, or the like. For example, the temperature and quality of influent water change with the change of seasons. The capacity of equipment changes as the equipment deteriorates over time. The activity states of microorganisms in water being treated and the treatment rate of the process change along with such changes. That is, the characteristics of wastewater treatment change with changes in the environments.

If the characteristics of the model are not able to follow changes in the environments of the wastewater treatment plant, the accuracy of the predicted value of the quality of effluent water calculated using the model will decrease. If the accuracy of the predicted value decreases, it is difficult to appropriately control the treatment process. Thus, in order to appropriately operate the treatment process, it is desirable that a model reflecting changes in the environments be used.

However, it is up to the user to determine when to adjust the model and whether to use the adjusted model. Further, it is not easy for the user to appropriately determine when to adjust the model and whether to use the adjusted model. Therefore, the model does not always follow changes in the environments of the treatment process.

A control system according to an embodiment of the present invention uses a model of a process relating to water treatment to calculate an output variable including an effluent water quality indicating the quality of effluent water flowing out of the process. The control system calculates an output variable based on input variables including an influent water quality indicating the quality of influent water flowing into the process and a manipulated value for the process. The control system acquires a combination that satisfies a predetermined constraint condition among combinations of the manipulated value and the output variable. The control system controls the process based on the manipulated value in the acquired combination.

The control system regenerates parameters indicating the characteristics of the model at regular intervals. The control system replaces the parameters of the model when the effluent water quality calculated according to the regenerated parameters is closer to a measured value of the effluent water quality than the effluent water quality calculated according to the parameters before regeneration.

This allows the control system to make the model follow changes in the environments of the treatment process.

### First Embodiment

### <Flow of Wastewater Treatment System>

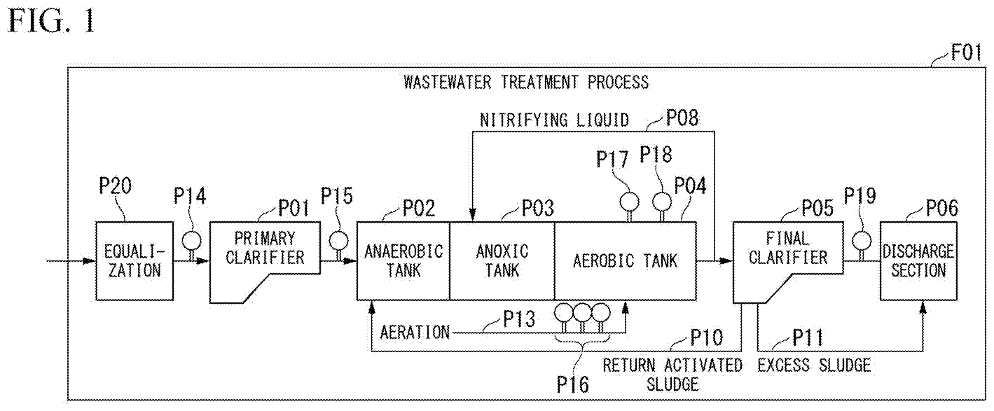

FIG. 1 is a block diagram showing an example of a general wastewater treatment system. FIG. 1 illustrates a wastewater treatment system based on an anaerobic-anoxic-aerobic method.

In a primary clarifier P01, solid matter contained in wastewater that has flowed in from an equalization P20 is settled and removed. Supernatant water from the primary clarifier P01 flows into an anaerobic tank P02 and return activated sludge is returned from a final clarifier P05 to the anaerobic tank P02 through a pipe P10. The pipe P10 connects the final clarifier P05 and the anaerobic tank P02. In the anaerobic tank P02, microorganisms ingest acetic acid and butyric acid in the water being treated and discharge phosphoric acid into the water being treated.

The water being treated flows into an anoxic tank P03 from the anaerobic tank P02 and return water (nitrifying liquid) containing nitrate nitrogen is returned from a stage downstream of an aerobic tank P04 through a pipe P08. The pipe P08 connects the stage downstream of the aerobic tank P04 and the anoxic tank P03. In the anoxic tank P03, nitric acid and oxygen contained in the nitrifying liquid are converted into nitrogen and released into the air (denitrification) by respiration of microorganisms.

In the aerobic tank P04, aeration P13 is applied to the water being treated that has flowed in from the anoxic tank P03. That is, in the aerobic tank P04, dissolved oxygen and ammonium nitrogen in the water being treated are converted into nitrate nitrogen (nitrification) by the aeration P13. The aeration P13 is controlled, for example, by controlling the airflow rate. Microorganisms ingest phosphorus in the aerobic tank P04.

In the final clarifier P05, activated sludge containing microorganisms which have ingested phosphorus is settled and removed (dephosphorized) from the water being treated that has flowed in from the aerobic tank P04 and supernatant water is discharged to a discharge section P06. Part of the settled activated sludge is returned to the anaerobic tank P02 from the final clarifier P05 through the pipe P10 as return activated sludge. The remaining activated sludge is discharged as excess sludge to the discharge section P06 through a pipe P11 that connects the final clarifier P05 and the discharge section P06.

### <Configuration of Control System>

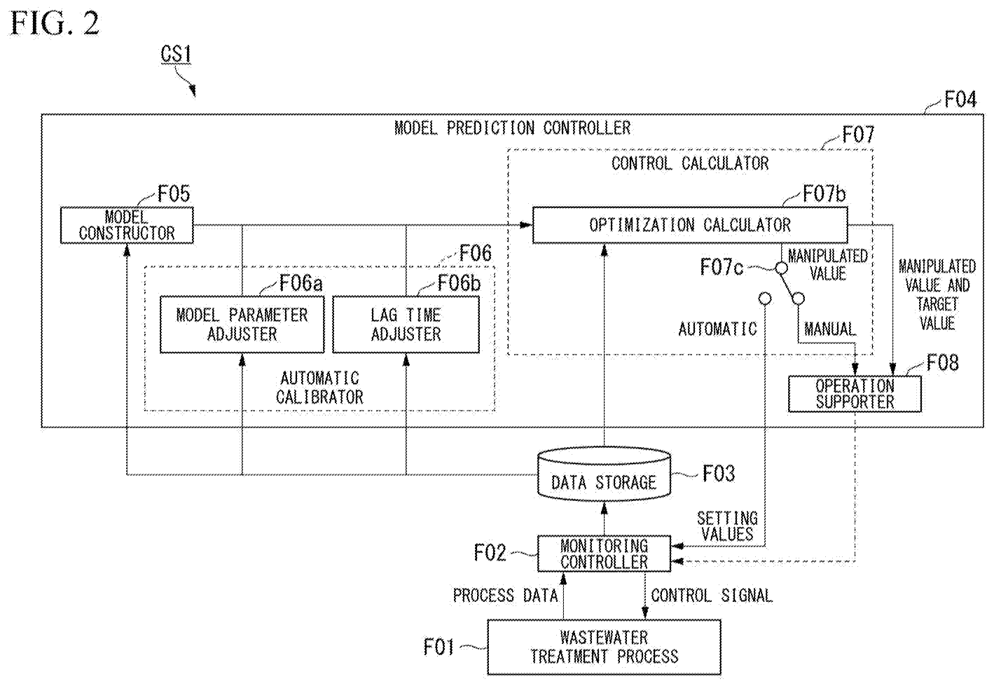

An exemplary configuration of a control system according to an embodiment of the present invention will be described. FIG. 2 is a block diagram showing the configuration of the control system CS1 according to the present embodiment. The control system CS1 shown in FIG. 2 is a wastewater treatment process control system including a monitoring controller F02, a data storage F03, and a model prediction controller F04.

A wastewater treatment process F01 shown in FIG. 2 has the same configuration as the wastewater treatment process F01 shown in FIG. 1. Process data is acquired from the wastewater treatment process F01 at regular intervals (for example, of 1 to 15 minutes) and output to the monitoring controller F02. The process data are values measured at measurement points in the wastewater treatment process F01.

The process data in the present embodiment includes, for example, an influent amount, an equalization water level, a turbidity, a dissolved oxygen (DO) (dissolved oxygen concentration), an NH₄—N (ammonium nitrogen concentration), a T-N (total nitrogen concentration), a T-P (total phosphorus concentration), and a chemical oxygen demand (COD). The values of process data are described below.

The influent amount is the amount of influent water that flows into the wastewater treatment process F01 per unit time. In the example shown in FIG. 1, the influent amount is the amount of water flowing into the equalization P20. In the example shown in FIG. 1, the pumping amount is the amount of water discharged from the equalization P20 to the primary clarifier P01. The pumping amount is measured by a sensor P14 installed at an inlet of the primary clarifier P01. The equalization water level indicates the water level of water stored in the equalization P20. The turbidity is an index indicating the degree of turbidity of water to be treated. In the example shown in FIG. 1, the turbidity is measured by a sensor P15 installed at a stage upstream of the anaerobic tank P04.

DO and NH₄—N are management indices of aeration P13 that is one step of the wastewater treatment process F01. DO indicates the concentration of oxygen dissolved in the water being treated. The DO in the aerobic tank P04 corresponds to the difference between the amount of air (amount of oxygen) supplied by aeration and the amount of oxygen consumed by microorganisms in the water being treated. NH₄—N indicates the concentration of ammonium nitrogen contained in the water being treated. NH₄—N is increased by decomposition of nitrogen compounds contained in the water being treated and the increased NH₄—N is reduced by microorganisms in the water being treated that have been activated by oxygen supplied thereto by aeration. In the example shown in FIG. 1, DO and NH₄—N are measured respectively by sensors P17 and P18 installed in the aerobic tank P04.

T-N, T-P, and COD are indices indicating the quality of effluent water (effluent water quality) that is discharged from the wastewater treatment process F01. T-N is the total concentration of nitrogen compounds contained in the effluent water. T-P is the total concentration of phosphate compounds contained in the effluent water. The COD indicates the amount of oxygen required to oxidize oxidizable substances in the effluent water. In the control system CS1 according to the present embodiment, any one of T-N, T-P, and COD may be adopted or two or all of them may be adopted. In the example shown in FIG. 1, T-N which is an effluent water quality is measured by a sensor P19 installed at an outlet of the final clarifier P05.

The monitoring controller F02 monitors or controls the state of the wastewater treatment process F01. The monitoring controller F02 stores process data sequentially input from the wastewater treatment process F01 in the data storage F03.

Also, output values from the model prediction controller F04 are input to the monitoring controller F02 as manipulated values for the wastewater treatment process F01. In addition, output values from the model prediction controller F04 may be input to the data storage F03. Further, output values from the model prediction controller F04 may be input to the monitoring controller F02 through the data storage F03 as manipulated values for the wastewater treatment process F01. The manipulated values include, for example, the pumping amount, the airflow rate, and the number of air blowers for controlling aeration P13 that is one step of the wastewater treatment process F01. The pumping amount indicates the amount of wastewater for treatment in the wastewater treatment process F01, that is, the amount of wastewater to be treated.

The monitoring controller F02 outputs control signals indicating manipulated values to the wastewater treatment process F01. The monitoring controller F02 stores the values of the manipulated values at time points in the data storage F03 in association with process data.

The monitoring controller F02 may include a display unit (display) that displays a monitoring screen. Process data and manipulated values at time points are displayed in time series on the monitoring screen. Information for controlling the processing of the model prediction controller F04 is displayed on the monitoring screen.

Depending on the size of the wastewater treatment process F01, the monitoring controller F02 may be realized in any form such as a monitoring panel (board), a programmable logic controller (PLC), a supervisory control and data acquisition (SCADA), or a distributed control system (DCS).

The data storage F03 includes a storage medium. The data storage F03 stores process data and manipulated values that are sequentially output from the monitoring controller F02. The data storage F03 accumulates process data and manipulated values at time points.

The data storage F03 may be configured to be integrated with either the monitoring controller F02 or the model prediction controller F04.

The model prediction controller F04 includes a model constructor F05, an automatic calibrator F06, a control calculator F07, and an operation supporter F08.

The model constructor F05 generates a model of the wastewater treatment process F01 on the basis of the process data read from the data storage F03. The model includes coefficients (a set of parameters) of a characteristic expression and information of lag times. The set of parameters represents the characteristics of the model. Lag times will be described later. For example, the model constructor F05 uses a plant model creation method described in Japanese Unexamined Patent Application Publication No. 2017-91056 to generate a model.

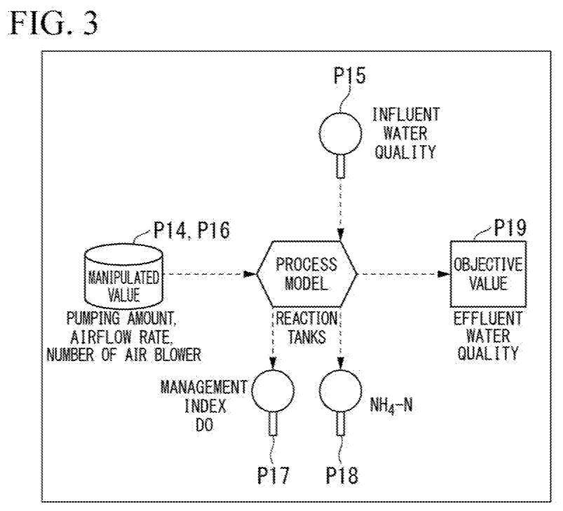

FIG. 3 is a diagram simply showing the model according to the present embodiment. The model shown in FIG. 3 is a mathematical model in which the influent water quality (turbidity) and manipulated values are input variables and management indices (DO, NH₄—N) and the effluent water quality are output variables. The manipulated values are the pumping amount, the airflow rate, and the number of air blowers.

The influent water quality is, for example, a measured value of the turbidity sensor P15 described above with reference to FIG. 1. The manipulated values are, for example, the pumping amount, the airflow rate, and the number of air blowers (P16) described above with reference to FIG. 1. The management indices are DO and NH₄—N in the reaction tanks described above with reference to FIG. 1. The effluent water quality is, for example, T-N.

The model constructor F05 generates a model (a set of parameters, lag times). The model constructor F05 calculates a set of parameters such that management indices and an effluent water quality calculated with the influent water quality (measured value) and manipulated values (actual values) as inputs approach their measured values. The model constructor F05 sets the calculated parameter set in a model definition file 312 stored in the optimization calculator F07b.

The model constructor F05 calculates the parameter set in consideration of the lag times of variables. The variables are the influent water quality (turbidity), the pumping amount, the airflow rate, the number of air blowers, DO, and NH₄—N. The lag time of each variable indicates the time delay from the change of the value of the variable to the time when the effluent water quality is affected by the change.

The model constructor F05 calculates the lag times of variables with respect to the effluent water quality. The model constructor F05 determines, for each variable, a correlation for each delay time. That is, the model constructor F05 determines, for each delay time, whether or not there is a correlation between the transition of a time-series value of the variable when the value of the variable has been delayed by the delay time and the transition of a time-series measured value of the effluent water quality. The model constructor F05 determines, for each variable, a delay time which maximizes the correlation as a lag time of the variable. The model constructor F05 sets the lag time of each variable in a lag time definition file 313 stored in the optimization calculator F07b.

The automatic calibrator F06 calibrates the model generated by the model constructor F05. The automatic calibrator F06 includes a model parameter adjuster F06a and a lag time adjuster F06b.

The model parameter adjuster F06a regenerates a set of parameters of the model on the basis of process data in a learning period at regular intervals. The model parameter adjuster F06a determines the prediction accuracy of the parameter set on the basis of process data in an evaluation period. The model parameter adjuster F06a updates the model when the prediction accuracy of the regenerated parameter set is higher than the prediction accuracy of the parameter set before regeneration. The parameter set before regeneration is a set of parameters before regeneration that are set in the optimization calculator F07b. The model parameter adjuster F06a regenerates the parameter set using the same method as that of the model constructor F05.

The lag time adjuster F06b performs a lag time adjustment process at regular intervals. The lag time adjuster F06b adjusts the lag time of each variable on the basis of an increase or decrease in the pumping amount, which is one of the manipulated values, in the learning period. The lag time adjuster F06b determines the prediction accuracy based on the adjusted lag time on the basis of process data in the evaluation period. The lag time adjuster F06b updates the model when the prediction accuracy based on the adjusted lag time is higher than the prediction accuracy based on the lag time set in the optimization calculator F07b.

The control calculator F07 includes an optimization calculator F07b and a switch F07c.

The optimization calculator F07b calculates predicted values using the parameter set in the model definition file 312 and the lag times in the lag time definition file 313. The optimization calculator F07b calculates management indices (DO, NH₄—N) and an effluent water quality (for example, T-N) corresponding to the influent water quality (for example, the turbidity) and the manipulated values as predicted values. A combination of the values of the influent water quality, the manipulated values, the management indices, and the effluent water quality will be referred to as a calculation set.

The optimization calculator F07b calculates a set of calculation values that satisfies a preset constraint condition. The optimization calculator F07b calculates, for example, a set that minimizes power cost. The optimization calculator F07b outputs the manipulated values included in the calculated set of calculation values to the switch F07c. The optimization calculator F07b outputs the manipulated values, the management indices, and the effluent water quality included in the calculated set of calculation values to the operation supporter F08.

When a manipulation signal input from the operation supporter F08 indicates automatic setting, the switch F07c outputs the manipulated values to the monitoring controller F02 as setting values. On the other hand, when the manipulation signal indicates manual setting, the switch F07c outputs the manipulated values to the operation supporter F08.

The operation supporter F08 has a function of supporting control and management of the wastewater treatment process F01. The operation supporter F08 is connected to a display unit (not shown) (for example, display) that displays information and an operation input unit (not shown) (for example, touch sensors, a mouse, and buttons).

The operation supporter F08 receives manipulated values through the switch F07c when the manipulation signal indicates manual setting. Upon receiving a manipulation signal indicating the application of manipulated values via the operation input unit, the operation supporter F08 outputs the manipulated values to the monitoring controller F02. The operation supporter F08 may receive inputs of the values of manipulated values via the operation input unit.

The operation supporter F08 may cause the display unit to display a management screen that shows the calculated values of the management indices and the effluent water quality input from the optimization calculator F07b in time series. The operation supporter F08 may cause the display unit to further display the values of the manipulated values input from the optimization calculator F07b on the management screen. The user can determine the validity of the manipulated values, the management indices, and the effluent water quality via the management screen. The management screen may further display preset reference values of the management indices and the effluent water quality.

The operation supporter F08 may cause the display unit to display a confirmation screen for automatic calibration. The operation supporter F08 causes the display unit to display a confirmation screen including predicted values of the effluent water quality in time series calculated using the parameter sets before and after the adjustment and the degrees of matching of the predicted values. The operation supporter F08 may also cause the display unit to display a confirmation screen including predicted values of the effluent water quality in time series calculated using lag times before and after adjustment and the degrees of matching of the predicted values.

The operation supporter F08 may receive a manipulation signal indicating a change in the learning period or the evaluation period via the confirmation screen. The operation supporter F08 may further receive a manipulation signal indicating a change in the upper limit value and the lower limit value of each of the management indices and the effluent water quality via the confirmation screen. A simulation result of a set of calculation values calculated when the upper limit value and the lower limit value have been changed may also be displayed.

### <Flow of Control Calculation Processing>

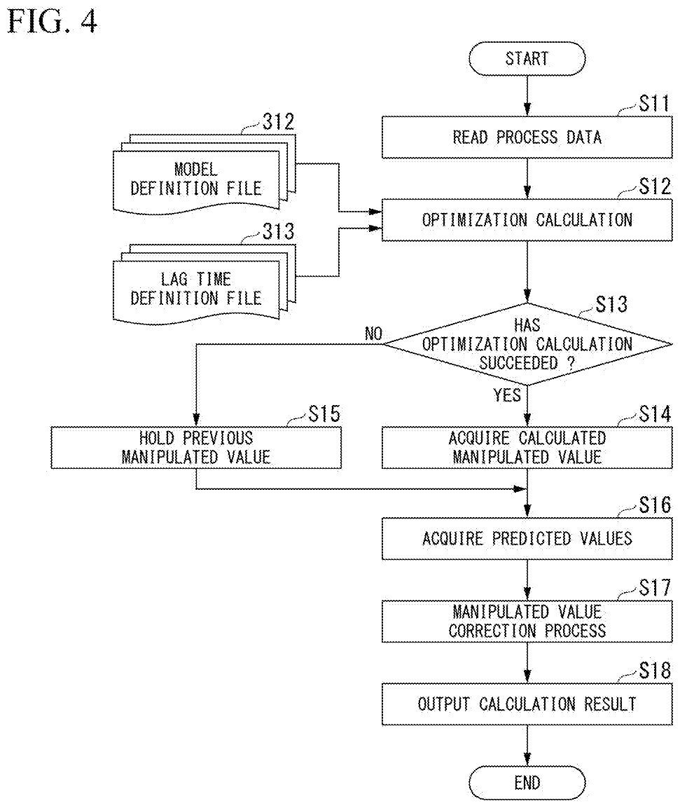

FIG. 4 is a flowchart showing an example of processing of the control calculator F07 according to the present embodiment. The control calculator F07 performs a control calculation process shown in FIG. 4 at regular intervals (for example, of 1 to 15 minutes).

(Step S11) The optimization calculator F07b reads process data at the present time point from the data storage F03. The process data to be read includes, for example, a turbidity, an equalization water level, and DO. The optimization calculator F07b also acquires information on a main flow rate. The main flow rate is the amount of influent from a main line per unit time. The main flow rate may be a predicted value or an actual value. The main flow rate is estimated, for example, on the basis of the weather and the day of the week.

(Step S12) The control calculator F07 performs optimization calculation. That is, the control calculator F07 uses the model to calculate DO and NH₄—N and the effluent water quality corresponding to the read turbidity and manipulated values under a predetermined constraint condition. The control calculator F07 also acquires a manipulated value that reduces power cost on the basis of the calculation result. Hereinafter, the process of step S12 will be described in detail.

The optimization calculator F07b reads the model definition file 312 and the lag time definition file 313 and acquires a parameter set and lag times. The optimization calculator F07b calculates the effluent water quality, DO, and NH₄—N on the basis of the turbidity and the manipulated values by using the parameter set and the lag times (model calculation).

In the model calculation, the optimization calculator F07b calculates the effluent water quality, DO, and NH₄—N after the elapse of a time corresponding to the lag time of each of the values of the turbidity and the manipulated values. When calculating DO, the optimization calculator F07b calculates the DO after the elapse of each time difference obtained by subtracting the lag time of the DO from the lag time of each of the values of the turbidity and the manipulated values. Each time difference corresponds to the lag time, with respect to the DO, of each of the values of the turbidity and the manipulated values. The same applies to the case of calculating NH₄—N.

The turbidity here is process data at the time point of calculation. The time point of calculation means the latest time point before the time point of calculation and may not exactly match the time of the latest time point. The manipulated values are the pumping amount, the airflow rate, and the number of air blowers in preset manipulation ranges. The manipulation ranges are ranges between the lower and upper limits of values that are realizable or allowed.

The manipulation range of the pumping amount may be preset or may be set dynamically on the basis of estimated values of the main flow rate and the equalization water level. The higher of a value that is lower than the airflow rate at that time by a predetermined ratio and the minimum output of the aeration equipment may be set as a lower limit of the manipulation range of the airflow rate. The lower of a value that is higher than the airflow rate at that time by a predetermined ratio and the maximum output of the aeration equipment may be set as an upper limit of the manipulation range of the airflow rate. For example, the range of the number of air blowers included in the aeration equipment is set as the manipulation range of the number of air blowers.

The optimization calculator F07b calculates a set of calculation values in which the turbidity and manipulated values and the calculated effluent water quality, DO, and NH₄—N, which satisfy the constraint condition, are associated with each other. The optimization calculator F07b performs calculation processing, for example, using overall combinations of input variables including the values of a turbidity and manipulated values as inputs.

The constraint condition is, for example, a condition that the effluent water quality be better than a predetermined reference value. When the index of the effluent water quality is T-N, T-P or COD, the smaller the value of the index, the better the effluent water quality. The constraint condition may further include a condition for a management index. The condition for a management index is, for example, a condition that the value of DO be better (that is, greater) than a predetermined reference value of the DO. Another condition for a management index is that the value of NH₄—N be better (that is, smaller) than a predetermined reference value of NH₄—N.

The optimization calculator F07b acquires a set of calculation values (an optimum solution) that minimizes power cost from sets of calculation values that satisfy the constraint condition. For example, the optimization calculator F07b estimates power cost in a predetermined period (for example, of 24 hours) assuming that control is performed on the basis of each set of calculation values. Then, the optimization calculator F07b acquires a set of calculation values (an optimum solution) that minimizes the power cost in a predetermined period. The optimum solution is derived, for example, according to an algorithm such as mixed integer programming (MILP).

The power cost changes according to the combination of the values of manipulated values (the pumping amount, the airflow rate, and the number of air blowers). Even when the same airflow rate is output, the power cost differs depending on the combination of the number of air blowers and the airflow period. The electricity charges also differ depending on the time zone. For example, nighttime electricity charges tend to be cheaper than daytime electricity charges. Therefore, even when the same pumping amount is treated, the power cost differs depending on the time zone of the treatment. For example, decreasing the pumping amount in the daytime zone and increasing in the nighttime zone can limit the power cost while maintaining a total pumping amount per day.

The plurality of air blowers differ, for example, in the type and rated voltage. Air blowers have individual differences and undergo different degrees of deterioration over time even when they are of the same type. Therefore, the power cost differs depending on which air blowers are activated even when they are controlled to output air at the same blowing rate. Therefore, the optimization calculator F07b may calculate a set of calculation values including identification information of the air blowers to be activated as a set of calculation values that minimizes the power cost.

The optimization calculator F07b may acquire a calculation set by using either the energy consumption or the CO₂ emission amount in addition to the power cost.

(Step S13) The optimization calculator F07b determines whether or not the optimization calculation has succeeded. When a set of calculation values satisfying the constraint has been acquired, the optimization calculator F07b determines that the optimization calculation has succeeded. On the other hand, when there is no set of calculation values satisfying the constraint condition, the optimization calculator F07b determines that the optimization calculation has failed.

(Step S14) When the optimization calculation has succeeded (YES in step S13), the optimization calculator F07b outputs the calculated manipulated values in the calculation set to the switch F07c. This allows the calculated manipulated values to be output to the operation supporter F08 or the monitoring controller F02. Next, the process proceeds to step S16.

(Step S15) On the other hand, when the optimization calculation has failed (NO in step S13), the optimization calculator F07b does not output a set of calculation values. Therefore, the operation supporter F08 and the monitoring controller F02 hold manipulated values that have been output last time. This avoids execution of control based on inappropriate manipulated values. Next, the process proceeds to step S16.

(Step S16) The optimization calculator F07b acquires predicted values of the management indices, the effluent water quality, and the equalization water level after hours to tens of hours, which are based on the set manipulated values. Specifically, the optimization calculator F07b calculates predicted values of management indices and the effluent water quality based on the turbidity and the set manipulated values using the model. The optimization calculator F07b calculates a predicted value of the equalization water level on the basis of the main flow rate acquired in step S11 and the set pumping amount.

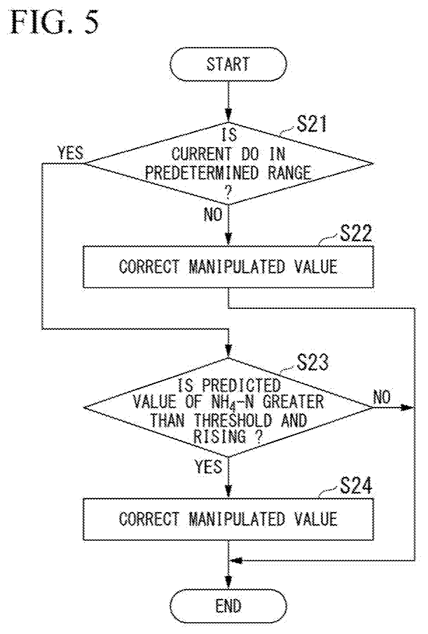

(Step S17) The optimization calculator F07b corrects the set manipulated values on the basis of the state of the aerobic tank P04. Correction of the manipulated values based on the state of the aerobic tank P04 can stabilize the state of the treatment process. The process of step S17 will be described later according to the flowchart of FIG. 5.

When the manipulated values have been corrected in step S17, the optimization calculator F07b may calculate predicted values of the effluent water quality and the equalization water level which are based on the corrected manipulated values.

(Step S18) The optimization calculator F07b causes the values of the manipulated values and the calculated predicted values of the effluent water quality and the equalization water level to be displayed on a management screen via the operation supporter F08. Here, the optimization calculator F07b may cause the operation plans of the plurality of air blowers to be displayed as manipulated values. For example, the optimization calculator F07b causes the operation pattern of each air blower several hours ahead to be displayed. This makes it possible to prepare in advance for switching the operations of air blowers.

FIG. 5 is a flowchart for explaining the process of correcting the airflow rate (step S17 in FIG. 4).

(Step S21) The optimization calculator F07b determines the current DO that is one of the management indices. Specifically, the optimization calculator F07b determines whether or not the current DO acquired in step S11 (FIG. 4) is included in a predetermined range of values.

(Step S22) The optimization calculator F07b corrects a manipulated value if the current DO is not included in the predetermined range of values (NO in S21). The optimization calculator F07b corrects, for example, the airflow rate. Specifically, when the current DO is below the predetermined range, the optimization calculator F07b increases the airflow rate by a value α. The value α is an arbitrary set value. This increases the amount of air (the amount of oxygen) supplied to the aerobic tank P04, activates microorganisms in the water being treated, and promotes the decomposition of NH₄—N. On the other hand, when the current DO is above the predetermined range, the optimization calculator F07b decreases the airflow rate by a value β. The value β is an arbitrary set value. This reduces the drive power of each air blower P16 and reduces the power cost in the wastewater treatment process F01. After the manipulated value is corrected, the process of the flowchart of FIG. 5 ends.

(Step S23) On the other hand, the optimization calculator F07b determines a predicted value of NH₄—N that is one of the management indices (for example, a predicted value thereof after 5 hours) if the current DO is included in the predetermined range of values (YES in S21). The optimization calculator F07b determines whether or not the predicted value of NH₄—N calculated in step S16 (in FIG. 4) exceeds an arbitrary threshold and is rising.

(Step S24) The effluent water quality is likely to deteriorate if NH₄—N exceeds the threshold and is rising (YES in S23). Thus, the optimization calculator F07b corrects a manipulated value. The optimization calculator F07b increases, for example, the airflow rate by a value y in order to supply oxygen and promote the decomposition of NH₄—N. The value y is an arbitrary set value. After the manipulated value is corrected, the process of the flowchart of FIG. 5 ends.

On the other hand, the effluent water quality is unlikely to deteriorate if NH₄—N is less than or equal to the threshold or is not rising (NO in S23). Thus, the optimization calculator F07b does not correct the manipulated value.

In this way, the optimization calculator F07b corrects a manipulated value on the basis of the current value and the predicted value of a management index indicating the state of the aerobic tank P04. This allows the aerobic tank P04 to be controlled such that it is stabilized when it is determined that the state of the aerobic tank P04 is unstable or when it is predicted that the aerobic tank P04 will be unstable. Therefore, it is possible to continue the operation of the treatment process while maintaining the water quality of the aerobic tank P04.

### <Parameter Set Adjustment Process>

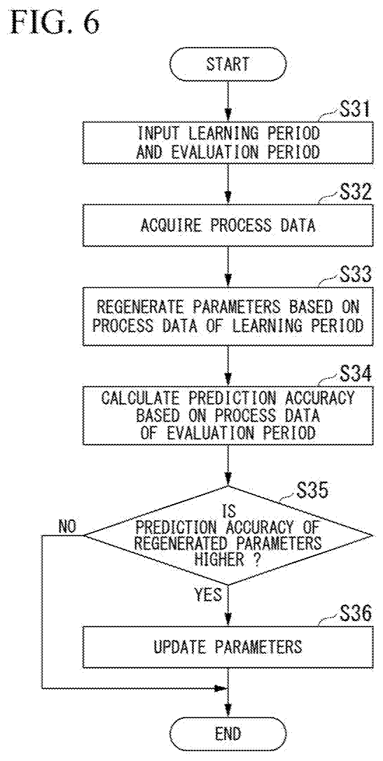

FIG. 6 is a flowchart showing an example of a process of adjusting a parameter set of a model according to the present embodiment. The model parameter adjuster F06a performs the parameter set adjustment process at regular intervals. For example, the model parameter adjuster F06a performs the parameter set adjustment process at predetermined times (for example, at 0:00 every Sunday) designated by a scheduler or the like.

(Step S31) The model parameter adjuster F06a acquires a learning period and an evaluation period. The learning period and the evaluation period are set, for example, via the operation input unit of the operation supporter F08. For example, the learning period is a one-week period from two weeks ago to one week ago. For example, the evaluation period is a one-week period following the learning period.

(Step S32) The model parameter adjuster F06a acquires process data in the learning period and the evaluation period from the data storage F03.

(Step S33) The model parameter adjuster F06a regenerates a set of parameters of the model on the basis of the process data in the learning period. The model parameter adjuster F06a regenerates a set of parameters on the basis of a turbidity, manipulated values, management indices, and an effluent water quality measured in the learning period. The method of generating the model is the same as that of the model constructor F05.

(Step S34) The model parameter adjuster F06a uses process data in the evaluation period to calculate prediction accuracies of the parameter sets before and after regeneration.

The model parameter adjuster F06a calculates an effluent water quality corresponding to the turbidity and the manipulated values measured in the evaluation period according to the regenerated parameter set. Lag times are taken into consideration when performing the model calculation as described above. The model parameter adjuster F06a calculates the degree of matching between the calculated effluent water quality and the effluent water quality measured in the evaluation period as an evaluation value of the prediction accuracy.

Similarly, the model parameter adjuster F06a calculates an effluent water quality corresponding to the turbidity and the manipulated values measured in the evaluation period according to the parameter set before regeneration (which is set in the optimization calculator F07b). Similarly, lag times are taken into consideration. The model parameter adjuster F06a calculates the degree of matching between the calculated effluent water quality and the effluent water quality measured in the evaluation period as an evaluation value of the prediction accuracy.

For example, any value such as a mean absolute percentage error (MAPE), a root mean squared error (RMSE), a correlation coefficient R, or a determination coefficient R2 can be used as an evaluation value of the accuracy. A larger MAPE and RMSE indicates a lower degree of matching. A larger correlation coefficient R indicates a higher degree of matching. A larger determination coefficient R2 indicates a higher degree of matching.

(Step S35) The model parameter adjuster F06a determines whether the prediction accuracy of the regenerated parameter set is higher than the prediction accuracy of the parameter set before regeneration. When the effluent water quality includes a plurality of variables, the model parameter adjuster F06a may perform the comparison on the basis of an average value of the degrees of matching of the variables. The model parameter adjuster F06a may also perform the comparison on the basis of the degree of matching of a variable having a high priority among the plurality of variables included in the effluent water quality.

(Step S36) The model parameter adjuster F06a updates the model if the prediction accuracy of the regenerated parameter set is higher than the prediction accuracy of the parameter set before regeneration (YES in step S35). That is, the model parameter adjuster F06a sets the regenerated parameter set in the model definition file 312.

On the other hand, the model parameter adjuster F06a does not update the model if the prediction accuracy of the regenerated parameter set is less than or equal to the prediction accuracy of the parameter set before regeneration (NO in step S35).

In this way, the model parameter adjuster F06a evaluates the parameter set regenerated based on the process data in the learning period on the basis of the process data in the evaluation period. The model parameter adjuster F06a updates the model only when the prediction accuracy of the regenerated parameter set is higher than the prediction accuracy of the parameter set that has been used. On the other hand, the model parameter adjuster F06a does not update the model when the prediction accuracy of the regenerated parameter set is less than or equal to the prediction accuracy of the parameter set that has been used.

Thus, the model is updated with the regenerated parameter set when it is determined that the prediction accuracy based on the regenerated parameter set is improved. Namely, the model is updated only when it is determined that the regenerated parameter set follows changes in the environments. In the present embodiment, a series of processes for updating the model only when it is determined that the regenerated parameter set follows changes in the environments is performed at regular intervals. This allows the characteristics of the model to follow changes in the environments.

Note that the evaluation period is the period following the learning period. That is, it is determined whether a parameter set regenerated based on process data of a previous period matches the characteristics of process data of a later period. This makes it possible to more appropriately determine whether the regenerated parameter set follows changes in the environments.

Also note that the model parameter adjuster F06a may display the effluent water qualities and the degrees of matching when parameter sets before and after adjustment are used via the operation supporter F08. Thus, it is possible to intuitively perceive the differences in the effluent water qualities and the degrees of matching which are based on the parameter sets before and after adjustment.

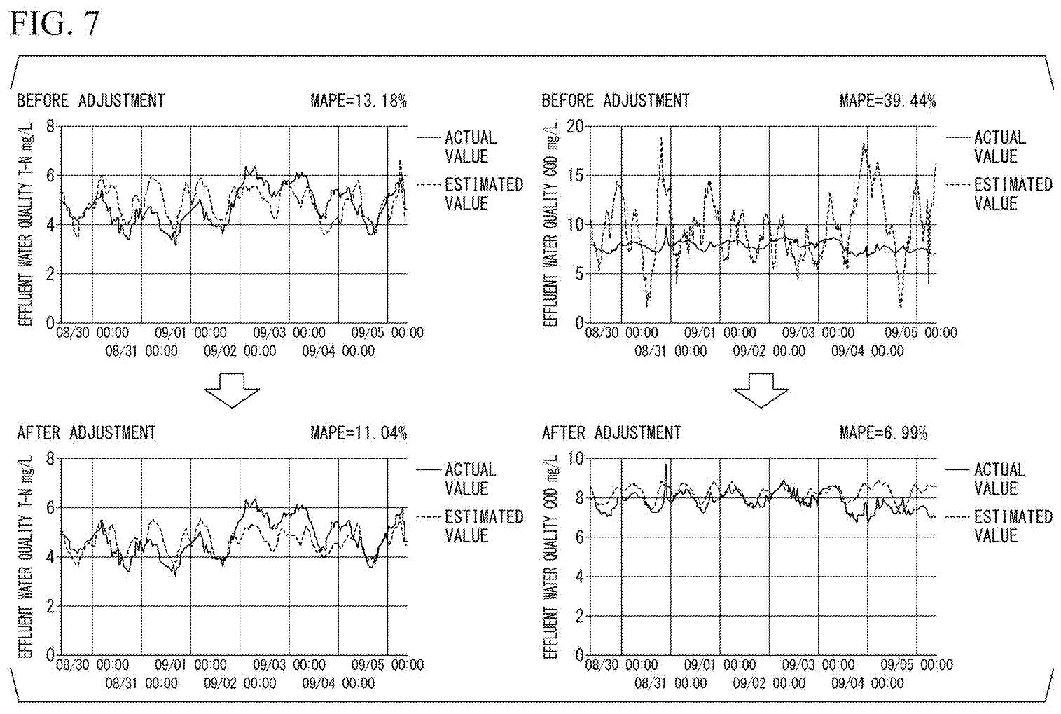

FIG. 7 is a diagram for explaining examples of the estimated values of the effluent water quality and the degrees of matching when parameter sets before and after adjustment are used.

The left upper part of FIG. 7 shows the time-series transitions of the actual value (measured value) and the estimated value (calculated value) of T-N in the evaluation period and the MAPE when the parameter set before adjustment is used. In this example, the MAPE is 13.18%. The right upper part of FIG. 7 shows the time-series transitions of the actual value (measured value) and the estimated value (calculated value) of COD in the evaluation period and the MAPE when the parameter set before adjustment is used. In this example, the MAPE is 39.44%.

The left lower part of FIG. 7 shows the time-series transitions of the actual and estimated values of T-N in the evaluation period and the MAPE when the adjusted parameter set is used. This MAPE is 11.04%. The right lower part of FIG. 7 shows the time-series transitions of the actual and estimated values of COD in the evaluation period and the MAPE when the adjusted parameter set is used. This MAPE is 6.99%.

The smaller the value of the MAPE, the higher the degree of matching. According to the example of FIG. 7, the degree of matching based on the parameter set after adjustment is higher than the degree of matching based on the parameter set before adjustment for both T-N and COD. For example, referring to the COD value shown in FIG. 7, the differences between actual and measured values after adjustment are smaller than the differences between the actual and measured values before adjustment. Thus, the model parameter adjuster F06a determines that the prediction accuracy of the model after adjustment is higher than the prediction accuracy of the model before adjustment.

### <Lag Time Adjustment Process>

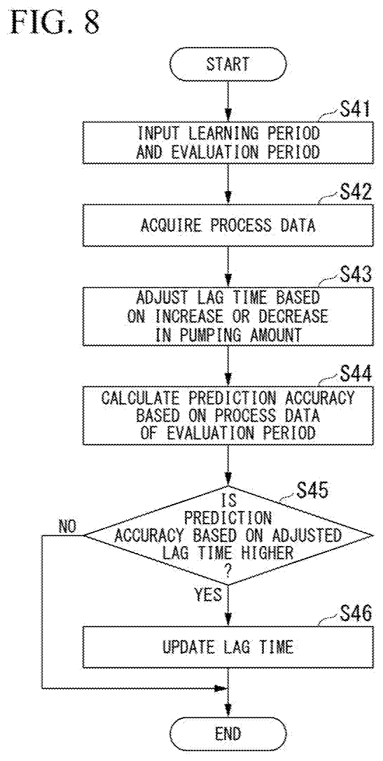

FIG. 8 is a flowchart showing an example of a process of adjusting lag times according to the present embodiment. The lag time adjuster F06b performs the lag time adjustment process at regular intervals. For example, the lag time adjuster F06b performs the lag time adjustment process at predetermined times (for example, at 0:00 on the first Sunday of every month) designated by a scheduler or the like.

The lag time adjustment process may be performed after the parameter set adjustment process. Alternatively, the lag time adjustment process may further be performed when the pumping amount has increased or decreased by a predetermined value or more.

(Step S41) The lag time adjuster F06b acquires a learning period and an evaluation period. The learning period and the evaluation period are set, for example, via the operation input unit of the operation supporter F08. The learning period and the evaluation period may be the same as or different from those of the parameter set adjustment process.

(Step S42) The lag time adjuster F06b acquires process data in the learning period and the evaluation period from the data storage F03.

(Step S43) The lag time adjuster F06b adjusts the lag time on the basis of an increase or decrease in the pumping amount in the learning period. In the present embodiment, the pumping amount is an example of a manipulated value and the value thereof increases and decreases. The flow rate of influent water into the reaction tanks changes according to increases or decreases in the pumping amount. The retention time of influent water in the reaction tanks changes according to changes in the flow rate of influent water into the reaction tanks and thus the lag time of each variable also changes. Therefore, the lag time adjuster F06b performs a lag time adjustment process according to the following equations 1 to 3.

Theoretical pumping amount retention time=volume of reaction tanks/pumping amount (Equation 1)

Lag time change rate=theoretical pumping amount retention time/initial value of lag time of pumping amount (Equation 2)

Adjusted lag time=initial value of lag time of each variable×lag time change rate (Equation 3)

The theoretical pumping amount retention time in Equation 1 indicates the period during which influent water stays in the reaction tanks (P02, P03, and P04 shown in FIG. 1). The flow rate of influent water increases as the pumping amount increases. Therefore, the time of influent water staying in the reaction tanks (P02, P03, and P04 shown in FIG. 1) (theoretical pumping amount retention time) becomes shorter when the pumping amount is great and becomes longer when the pumping amount is small.

In Equation 2, the lag time change rate is calculated on the basis of the theoretical pumping amount retention time and the initial value of the lag time of the pumping amount. The lag time change rate becomes less than “1” if the theoretical pumping amount retention time becomes shorter with an increase in the pumping amount. On the other hand, the lag time change rate becomes “1” or more if the theoretical pumping amount retention time becomes longer with a decrease in the pumping amount.

In Equation 3, the adjusted lag time is calculated by multiplying the lag time of the initial value by the lag time change rate calculated in Equation 2 for each variable. Specifically, the lag time of the pumping amount is adjusted such that it decreases if the theoretical pumping amount retention time decreases with an increase in the pumping amount. On the other hand, the lag time of the pumping amount is adjusted such that the lag time increases if the theoretical pumping amount retention time increases with a decrease in the pumping amount.

Thus, according to Equations 1 to 3, the lag time is adjusted based on the rate of change of the retention time of influent water in the reaction tanks (P02, P03, and P04) according to an increase or decrease in the pumping amount. Therefore, even if the pumping amount increases or decreases, the lag time is appropriately adjusted according to how much the pumping amount increases or decreases. This makes it possible to maintain the accuracy of predicting the effluent water quality even if the value of the pumping amount changes.

(Step S44) The lag time adjuster F06b calculates prediction accuracies based on lag times before and after adjustment using process data in the evaluation period. The evaluation value of each prediction accuracy is similar to that of the degree of matching of each parameter set.

The lag time adjuster F06b calculates an effluent water quality corresponding to the turbidity and the manipulated values measured in the evaluation period according to the parameter set and the adjusted lag time. The lag time adjuster F06b calculates the degree of matching between the calculated effluent water quality and the effluent water quality measured in the evaluation period as an evaluation value of the prediction accuracy.

Similarly, the lag time adjuster F06b calculates an effluent water quality corresponding to the turbidity and the manipulated values measured in the evaluation period according to the parameter set and the lag time before adjustment. The lag time adjuster F06b calculates the degree of matching between the calculated effluent water quality and the effluent water quality measured in the evaluation period as an evaluation value of the prediction accuracy.

(Step S45) The lag time adjuster F06b determines whether the prediction accuracy when the adjusted lag time is used is higher than the prediction accuracy when the lag time before adjustment is used. When the effluent water quality includes a plurality of variables, the lag time adjuster F06b may perform the comparison on the basis of an average value of the degrees of matching of the variables. The lag time adjuster F06b may also perform the comparison on the basis of the degree of matching of a variable having a high priority among the plurality of variables included in the effluent water quality.

(Step S46) The lag time adjuster F06b updates the lag time if the prediction accuracy when the adjusted lag time is used is higher than the prediction accuracy when the lag time before adjustment is used (YES in step S45). That is, the lag time adjuster F06b sets the adjusted lag time in the lag time definition file 313.

On the other hand, the lag time adjuster F06b does not update the lag time if the prediction accuracy when the adjusted lag time is used is less than or equal to the prediction accuracy when the lag time before adjustment is used (NO in step S45).

In this way, the lag time adjuster F06b evaluates the lag time adjusted based on the process data in the learning period on the basis of the process data in the evaluation period. The lag time adjuster F06b updates the lag time only when the prediction accuracy based on the adjusted lag time is higher than the prediction accuracy based on the lag time that has been used. On the other hand, the lag time adjuster F06b does not update the lag time when the prediction accuracy based on the adjusted lag time is less than or equal to the prediction accuracy based on the lag time that has been used.

Thus, the model is updated with the adjusted lag time when it is determined that the prediction accuracy based on the adjusted lag time is improved. Namely, the lag time is updated only when it is determined that the adjustment of the lag time follows changes in the environments. In the present embodiment, a series of processes for updating the model only when it is determined that the adjusted lag time follows changes in the environments is performed at regular intervals. This allows the model to follow changes in the environments even if the pumping amount that is one of the manipulated values increases or decreases.

The lag time adjuster F06b may display the effluent water qualities and the degrees of matching when lag times before and after adjustment are used via the operation supporter F08. Thus, it is possible to intuitively perceive changes in the effluent water qualities and the degrees of matching which are based on the lag times before and after adjustment.

### <Model Calculation Method>

Next, an example of a model calculation method performed by the model constructor F05 and the model parameter adjuster F06a will be described. Model parameter calculation processing described in Japanese Unexamined Patent Application Publication No. 2017-91056 includes processes that will be described below.

In the present embodiment, management indices and an effluent water quality are calculated as objective variables. Therefore, the model constructor F05 and the model parameter adjuster F06a define, for example, the following vector values (1) to (3): (1) a vector value including the pumping amount, the turbidity, the airflow rate, the number of air blowers, and DO, (2) a vector value including the pumping amount, the turbidity, the airflow rate, the number of air blowers, and NH₄—N, and (3) a vector value including the pumping amount, the turbidity, the airflow rate, the number of air blowers, and an effluent water quality.

The vector value (1) includes the turbidity and manipulated values at time points, which are earlier than a time point when DO is calculated (a target time point) by lag times, with respect to DO, of the turbidity and manipulated values, and DO at the target time point. The vector value (2) includes the turbidity and manipulated values at time points, which are earlier than the target time point by lag times, with respect to NH₄—N, of the turbidity and manipulated values, and NH₄—N at the target time point. The vector value (3) includes the turbidity and manipulated values at time points, which are earlier than the target time point by lag times, with respect to effluent water quality, of the turbidity and manipulated values, and an effluent water quality at the target time point.

The model constructor F05 and the model parameter adjuster F06a perform the following steps S51 to S57 (not shown) for each vector value (1) to (3) at each target time point. Hereinafter, these vector values are simply referred to as vector values.

(Step S51) Outlier removal: an average value μ and a variance/covariance matrix V of vector values xᵢ in the learning period are calculated. Then, a Mahalanobis distance D(xᵢ) from the average value μ for vector values xᵢ at time points in the learning period is calculated using the average value μ and the variance/covariance matrix V (Expression (4)).

D²(xᵢ)=(xᵢ−μ)^{T}V⁻¹(xᵢ−μ) (4)

In Expression (4), T represents the transpose of a vector or matrix. V⁻¹ represents the inverse of the variance/covariance matrix.

Thereafter, a cumulative value is calculated by integrating a χ² distribution P(D) (Expression (5)) as a probability distribution from 0 to a normalized value.

$$P ( D ) = \frac{{D}^{\frac{t}{2} - 1} \cdot {e}^{- \frac{D}{2}}}{{2}^{\frac{1}{2}} \cdot ( \frac{t}{2} )} \qquad ( 5 )$$

Vector values that give a cumulative value exceeding a predetermined threshold TH0 (for example, 0.95 to 0.98) are removed as outliers. Then, vector values left without being removed are saved. Thereafter, the process proceeds to step S52.

(Step S52) Clustering: the stored set of vector values is classified into a plurality of clusters, each showing a common tendency or pattern, for example, by using a Gaussian mixture model (GMM). For example, the set of vector values is classified into a plurality of clusters such that the overall sum of squares of Mahalanobis distances of vector values from a straight line that approximates the distribution of vector values in each cluster is minimized. Here, the process of dividing a region over which the set of vector values distribute is repeated until the number of regions obtained by the division reaches a predetermined maximum number of divisions (for example, 8 to 16). Then, the process proceeds to step S53.

(Step S53) Principal component list generation: principal component analysis (PCA) is performed on normalized data X′^{data} obtained by normalizing process data X^{data} including vector values classified into clusters with an average value m and a standard deviation s. As a result, principal components C′_{N}(C′₁, C′₂, . . . , C′ₙ) and contribution rates CR(j) of principal components j are calculated according to Expression (7). The principal components are ordered in a descending order of the contribution rate CR.

Here, the process data X^{data} is expressed as in Expression (6).

X^{data}=[x₁^{data}, x₂^{data}, . . . , xₙ^{data}]^{T}∈R^{N×I} (6)

In Expression (6), n represents the number of variables. I represents the number of clusters obtained by clustering, that is, the maximum number of divisions.

$$CR ( j ) = \frac{{λ}_{j}}{{\sum }_{i = 1}^{n} {λ}_{i}} = \frac{{λ}_{j}}{p} \qquad ( 7 )$$

In Expression (7), λⱼ represents the eigenvalue of a j-th principal component. This eigenvalue represents the variance of the j-th principal component. Then, the process proceeds to step S54.

(Step S54) Cumulative contribution rate calculation: the sum of contribution rates from the contribution rate CR(1) of the 1st principal component C′₁ to the contribution rate CR(j) of the j-th principal component C′ⱼ is calculated as a cumulative contribution rate CCR(j) for each principal component j as shown in Expression (8). Then, the process proceeds to step S55.

$$CCR ( j ) = {\sum }_{i = 1}^{j} CR ( i ) \qquad ( 8 )$$

(Step S55) Principal component discarding: principal components whose cumulative contribution rates CCR(j) are less than a predetermined threshold cumulative contribution rate TH1 (for example, 0.95 to 0.98) are discarded. As a result, principal components having high contribution rates CR are discarded and principal components having relatively low contribution rates that are left without being discarded are stored in the principal component list. Then, the process proceeds to step S56.

(Step S56) Characteristic expression calculation: a plane equation whose normal vectors are the remaining k principal components C′_{K}(C′₁, C′₂, . . . , C′ₖ) is calculated as a characteristic expression. The calculated characteristic expression is expressed as in Expression (9).

C′ₖ(X′_{N})=[c′_{k,1}·x′₁+c′_{k,2}·x′₂+ . . . +c′_{k,n}·x′ₙ=0]∈R^{N×I} (9)

In Expression (9), c′_{k,1} to c′_{k,n} represent 1st to n-th dimension components of the k-th principal component. x′₁ to x′ₙ represent 1st to n-th dimension components of the normalized vector value.

In the generated model, a large amount of process data distribute over a plane whose normal vectors are principal components having low contribution rates. The generated characteristic expression has the form of a constraint condition expression whose right term is 0. The generated characteristic expression may include, for example, a correlation expression such as that of the various material balances and other relational expressions representing unclear physical relations in addition to an input/output relational expression of equipment. Thus, the generated characteristic expression represents characteristics of the wastewater treatment process F01.

The generated characteristic expression is normalized. Therefore, using the average value and the variance/covariance of each vector value xᵢ, the generated characteristic expression is denormalized and converted into a characteristic expression in which values are returned to actual amounts as shown in Expression (10).

c_{k,1}(x₁−m₁)+c_{k,2}(x₂−m₂)+ . . . +c_{k,n}(xₙ−mₙ)=0⇒c_{k,1}·x₁+c_{k,2}·x₂+ . . . +c_{k,n}·xₙ+bₖ=0 (10)

In Expression (10), c_{k,1} to c_{k,n} are calculated by dividing c′_{k,1} to c′_{k,n} by the standard deviation s, respectively. m₁ to mₙ represent the 1st to n-th components of the average value m, respectively. bₖ is the total sum of −c_{k,1}·m₁ to −c_{k,n}·mₙ.

A model expression for calculating the objective variables is obtained from the converted characteristic expression by moving the management indices or effluent water quality as the objective variables to the left-hand side and moving the other terms to the right-hand side. Parameters acting on the turbidity (influent water quality) and the manipulated values (the pumping amount, the airflow rate, and the number of air blowers) in the obtained model expression correspond to the parameters of the above model.

As described above, the control system CS1 according to the present embodiment includes the control calculator F07, the monitoring controller F02, and the automatic calibrator F06. Using a model of a process relating to water treatment, the optimization calculator F07b of the control calculator F07 calculates an output variable including an effluent water quality indicating the quality of effluent water flowing out of the process. Using the model, the optimization calculator F07b calculates the output variable on the basis of input variables including an influent water quality indicating the quality of influent water flowing into the process and a manipulated value for the process. The optimization calculator F07b of the control calculator F07 acquires a combination that satisfies predetermined constraint conditions among combinations of the manipulated value and the output variable.

The monitoring controller F02 controls the process on the basis of the manipulated value in the combination acquired by the control calculator F07.

The model parameter adjuster F06a of the automatic calibrator F06 regenerates parameters indicating the characteristics of the model at regular intervals. The model parameter adjuster F06a replaces the parameters of the model when the effluent water quality calculated according to the regenerated parameters is closer to a measured value of the effluent water quality than the effluent water quality calculated according to the parameters before regeneration.

With this configuration, a parameter set of the model is regenerated at regular intervals and the model is updated only when the prediction accuracy based on the regenerated parameter set is higher. On the other hand, the model is not updated if the prediction accuracy based on the regenerated parameter set is not higher. In this way, a series of processes for updating the model only when it is determined that the regenerated parameter set follows changes in the environments is performed at regular intervals.

Accordingly, even if the environments of the treatment process change, the model can be adjusted such that a predicted effluent water quality approximates an effluent water quality actually measured in the treatment process. Thus, it is possible to maintain the prediction accuracy of the effluent water quality regardless of changes in the environments of the treatment process. Thereby, it is possible to appropriately control the operation of the treatment process.

Wastewater treatment process models include, for example, an activated sludge model (ASM) in addition to the model described in Japanese Unexamined Patent Application Publication No. 2017-91056 described above. The ASM is a model that the International Water Association (IWA) has proposed in order to deal with changes in the influent water quality and enable full performance of wastewater treatment methods.

The ASM is constructed of cells divided according to functions (processes) of wastewater treatment. The ASM includes a model calculation in consideration of various forms of organic matter, nitrogen, phosphorus, related microbial mass, precipitates, and the like for each cell. To follow changes in the environments of the wastewater treatment process, it is necessary to adjust parameters of the model at regular intervals. However, it takes a lot of time and work to adjust the parameters of the ASM model. On the other hand, the control system CS1 according to the present embodiment can reduce the burden on the operation of the process because the control system CS1 does not use the ASM. That is, it is possible to realize control that follows changes in the environments with a smaller burden.

In the control system CS1, the model parameter adjuster F06a regenerates parameters on the basis of input variables and an output variable measured in a first period. The model parameter adjuster F06a calculates an effluent water quality according to the regenerated parameters on the basis of input variables measured in a second period. The model parameter adjuster F06a calculates an effluent water quality according to the parameters before regeneration on the basis of the input variables measured in the second period. The model parameter adjuster F06a replaces the parameters with the regenerated parameters when the effluent water quality calculated according to the regenerated parameters is closer to an effluent water quality measured in the second period than the effluent water quality calculated according to the parameters before regeneration.

With this configuration, it is determined whether or not a parameter set regenerated based on measured values of the first period (learning period) matches the characteristics of measured values of the second period (evaluation period). Thereby, it is determined whether or not a set of parameters regenerated according to measured values of a previous period matches the characteristics of measured values of a later period. Therefore, it is possible to appropriately determine whether or not the regenerated parameter set follows changes in the environments.

In the control system CS1, manipulated values include an airflow rate of aeration and a pumping amount indicating the amount of influent water that is caused to flow into the process. The influent water quality includes a turbidity. The effluent water quality includes at least one of total nitrogen concentration, total phosphorus concentration, and chemical oxygen demand.

With this configuration, it is possible to derive an airflow rate and a pumping amount that satisfy the constraint condition. That is, an optimal value of the pumping amount in addition to an optimal value of the airflow rate can be acquired as manipulated values. Therefore, the treatment process can be controlled more flexibly.

The lag time adjuster F06b adjusts a lag time corresponding to the effluent water quality for each input variable on the basis of an increase or decrease in the pumping amount. With this configuration, even if the retention time of influent water in the reaction tanks (P02, P03, and P04) changes due to an increase or decrease in the pumping amount, the lag time can be appropriately adjusted such that it follows the change. Therefore, it is possible to maintain the prediction accuracy even if the value of the pumping amount changes.

The lag time adjuster F06b acquires a combination that minimizes the total power cost in a predetermined period among combinations satisfying the predetermined constraint condition on the basis of information on power cost according to the time zone. With this configuration, it is possible to use a model that reduces power cost while following changes in the environments of the treatment process. That is, it is possible to improve the accuracy of predicting the effluent water quality and reduce the power cost at the same time.

### (Modification 1)

The above embodiment has been exemplified by the case of applying a model for optimization calculation of a process of a wastewater treatment system. However, the treatment process to which treatment of the present embodiment is applicable is not limited to wastewater treatment. For example, treatment of the present embodiment may be applied to a sludge treatment process.

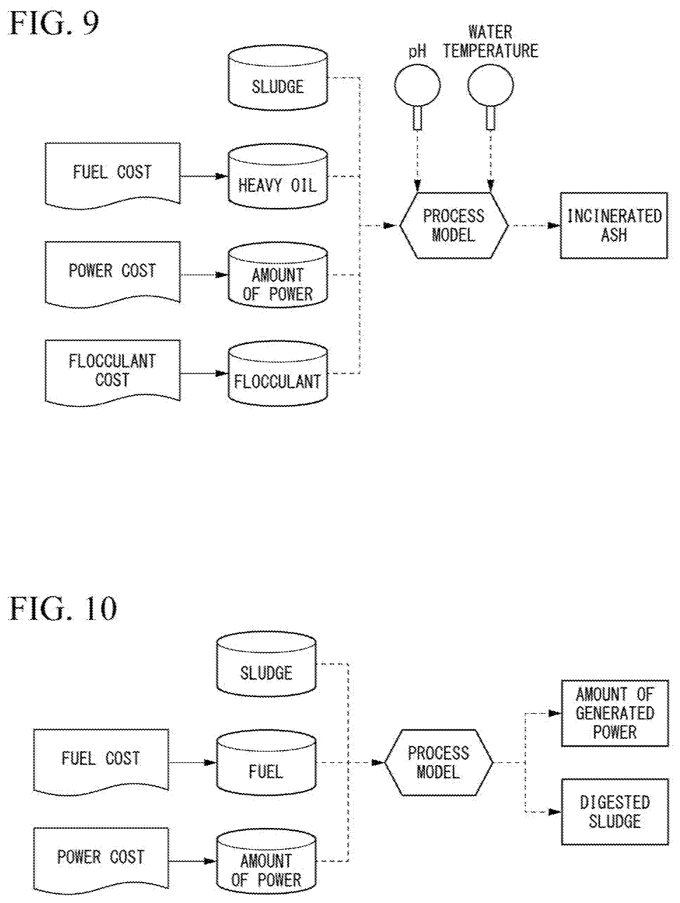

FIG. 9 is a diagram simply showing a model in the sludge treatment process. The model shown in FIG. 9 is a mathematical model having the amount of sludge, the amount of heavy oil, the amount of electric power (kW), the amount of flocculant, a hydrogen ion index (pH) and water temperature as input variables and the amount of incinerated ash as an output variable. Characteristics between the input variables and the output variable are generated as a model for optimization calculation.

By using the model for optimization calculation shown in FIG. 9, it is possible to derive the values of the input variables from which a desired amount of incinerated ash is output. Here, it is possible to derive optimal values of the input variables from which a desired amount of incinerated ash is output while limiting power cost, fuel cost, and flocculant cost.

### (Modification 2)

Treatment of the present embodiment may also be applied to a treatment process for digestion gas power generation. FIG. 10 is a diagram simply showing a model in a treatment process for digestion gas power generation. A model shown in FIG. 10 is a mathematical model having the amount of sludge, the amount of fuel, and the amount of electric power (kW) as input variables and the amount of generated power (kW) and the amount of digested sludge as output variables. Characteristics between the input variables and the output variables are generated as a model for optimization calculation.

By using the model for optimization calculation shown in FIG. 10, it is possible to derive the values of the input variables from which desired amounts of generated power and digested sludge are output. Here, it is possible to derive optimal values of the input variables from which desired amounts of generated power and digested sludge are output while limiting power cost and fuel cost.

Although embodiments of the present invention have been described above with reference to the drawings, the specific configurations thereof are not limited to those described above and various design changes and the like can be made without departing from the spirit of the present invention.

The above model has been illustrated with reference to an example where the turbidity which is an influent water quality and the pumping amount, the airflow rate, and the number of the air blowers which are manipulated values are used as input variables. The above simplified model has been illustrated with reference to an example where DO and NH₄—N which are management indices and T-N which is an effluent water quality are used as output variables. However, the present invention is not limited to these examples. More or less variables than described above may be used as input and output variables in the model.

For example, either the amount of return activated sludge that is returned from the final clarifier P05 to the anaerobic tank P02 or the amount of excess sludge may further be added as a manipulated value. The amount of return activated sludge and the amount of excess sludge are related to A-SRT (sludge retention time in the aerobic tank).

A management index may be the amount of substance that increases or decreases depending on a manipulation. For example, when the manipulation in the process is stirring, the management index may be phosphate phosphorus concentration that decreases with stirring. One of DO and NH₄—N which are management indices may be omitted.

T-P, COD, oxidation reduction potential (ORP), or potential hydrogen (pH) in addition to T-N which is an effluent water quality may be applied as measured values input (sensor inputs) from the process.

Further, the model constructor F05, the model parameter adjuster F06a, and the optimization calculator F07b may use a different model as a model representing the relationship between input and output variables. That is, a multi-stage model including models connected in series may be used instead of the model described above. For example, a model including a first model and a second model connected in series is used. The first model uses the amount of sludge returned to the anaerobic tank P02 as a manipulated value. The second model uses an output variable from the first model as an input variable and uses the airflow rate in the aerobic tank P04 as a manipulated value.

Further, such a model is not limited to a wastewater treatment process which adopts the A2O method and may be applied to a wastewater treatment process that adopts other methods such as, for example, an anaerobic aerobic (Anaerobic-Oxic (AO)) method or an anaerobic nitrification endogenous denitrification method (Anaerobic-Oxic-Anoxic-Oxic (AOAO)) method.

A monitoring device including the monitoring controller F02 and a model prediction control device including the data storage F03 and the model prediction controller F04 may be realized as separate devices. The model prediction controller F04 may also be integrated with the monitoring controller F02 and the data storage F03 such that they are realized as a control device. Further, the operation supporter F08 may be omitted from the model prediction controller F04 and the operation supporter F08 may be realized as a separate operation support device.

Furthermore, the model constructor F05 may be omitted if the optimization calculator F07b can acquire the initial model definition file 312 and the initial lag time definition file 313. For example, the optimization calculator F07b may acquire the model definition file 312 and the lag time definition file 313 from a server device installed outside.

Each device may be realized by a computer. In this case, a program for realizing the functions of each device may be recorded on a computer readable recording medium. Each device may be realized by causing a computer system to read the program recorded on the recording medium and execute the read program through an arithmetic processing circuit such as a CPU.

The “computer system” referred to here is a computer system that is embedded in each device and includes an OS or hardware such as peripheral devices. The “computer readable recording medium” refers to a portable medium such as a flexible disk, a magneto-optical disc, a ROM, or a CD-ROM, a storage device such as a hard disk provided in the computer system, or the like.

The “computer readable recording medium” may include something that dynamically holds a program for a short time, like a communication wire in the case in which the program is transmitted via a communication line such as a telephone line or a network such as the Internet. The “computer readable recording medium” may also include something that holds a program for a certain period of time, like an internal volatile memory of a computer system that serves as a server or a client in the case where the program is transmitted.

The program may be one for realizing some of the above-described functions. The program may also be one which can realize the above-described functions in combination with a program already recorded in the computer system. Further, the computer system described above may be configured as a computing resource unit that is a component of a cloud computing system. Here, components of the cloud computing system can transmit and receive various data to and from each other via a network.

Also, some or all of the above devices may be realized as an integrated circuit such as large scale integration (LSI). Functional blocks of each device may be individually implemented as processors or some or all of the functional blocks may be integrated and implemented as a processor. The circuit integration is not limited to LSI and may be realized by a dedicated circuit or a general-purpose processor. Further, if an integrated circuit technology that replaces LSI emerges with the progress of semiconductor technology, an integrated circuit according to the technology may be used.

[Supplementary Note]

(1) The present invention provides a control system which may include: a calculator configured to calculate, using a model of a process relating to water treatment, an output variable including an effluent water quality indicating a quality of effluent water flowing out of the process based on input variables including an influent water quality indicating a quality of influent water flowing into the process and a manipulated value for the process, the calculator being configured to acquire a combination satisfying a predetermined constraint condition among combinations of the manipulated value and the output variable; a controller configured to control the process based on the manipulated value in the combination acquired by the calculator; and a calibrator configured to regenerate a parameter representing a characteristic of the model at regular intervals and to replace the parameter of the model with the regenerated parameter when the effluent water quality calculated according to the regenerated parameter is closer to a measured value of the effluent water quality than the effluent water quality calculated according to the parameter before regeneration.

(2) Another aspect of the present invention provides the control system of aspect (1), wherein the calibrator is configured to: regenerate the parameter based on the input variables and the output variable measured in a first period; and replace the parameter of the model with the regenerated parameter when the effluent water quality calculated according to the regenerated parameter based on the input variables measured in a second period is closer to the effluent water quality measured in the second period than the effluent water quality calculated according to the parameter before regeneration based on the input variables measured in the second period.

(3) Another aspect of the present invention provides the control system of aspect (1) or (2), wherein the manipulated value includes an airflow rate of aeration and a pumping amount indicating an amount of the influent water that is caused to flow into the process, wherein the influent water quality includes a turbidity, and wherein the effluent water quality includes at least one of total nitrogen concentration, total phosphorus concentration, or chemical oxygen demand.

(4) Another aspect of the present invention provides the control system of aspect (3), wherein the calibrator is configured to adjust a lag time corresponding to the effluent water quality for each of the input variables based on an increase or decrease in the pumping amount.

(5) Another aspect of the present invention provides the control system of aspect (1), wherein the calculator is configured to acquire the combination that minimizes total power cost in a predetermined period among the combinations satisfying the predetermined constraint condition based on information on power cost according to a time zone.

(6) Another aspect of the present invention provides the control system of aspect (5), wherein the calculator is configured to acquire the combination by using either an energy consumption or a CO₂ emission amount in addition to the power cost.

(7) Another aspect of the present invention provides the control system of aspect (1), wherein the constraint condition is a condition that the effluent water quality be better than a predetermined reference value.

(8) Another aspect of the present invention provides the control system of aspect (1), wherein the calculator is configured to: acquire process data including a dissolved oxygen concentration indicating a concentration of oxygen dissolved in water being treated; increase an airflow rate of aeration when the dissolved oxygen concentration is below a predetermined range; and decrease the airflow rate when the dissolved oxygen concentration is above the predetermined range.

(9) Another aspect of the present invention provides the control system of aspect (8), wherein the calculator is configured to: acquire process data including an ammonium nitrogen concentration of the water being treated; and increase an airflow rate of aeration when the ammonium nitrogen concentration exceeds a threshold and is rising.

(10) Another aspect of the present invention provides the control system of aspect (4), wherein the lag time indicates a time delay from a change of a value of the input variables to a time when the effluent water quality is affected by the change.

(11) Another aspect of the present invention provides a control method performed by a control system which includes a calculator, a controller, and a calibrator, the control method including: calculating, by the calculator, using a model of a process relating to water treatment, an output variable including an effluent water quality indicating a quality of effluent water flowing out of the process based on input variables including an influent water quality indicating a quality of influent water flowing into the process and a manipulated value for the process; acquiring, by the calculator, a combination satisfying a predetermined constraint condition among combinations of the manipulated value and the output variable; controlling, by the controller, the process based on the manipulated value in the combination acquired by the calculator; regenerating, by the calibrator, a parameter representing a characteristic of the model at regular intervals; and replacing, by the calibrator, the parameter of the model with the regenerated parameter when the effluent water quality calculated according to the regenerated parameter is closer to a measured value of the effluent water quality than the effluent water quality calculated according to the parameter before regeneration.

(12) Another aspect of the present invention provides the control method of aspect (11), further including: regenerating, by the calibrator, the parameter based on the input variables and the output variable measured in a first period; and replacing, by the calibrator, the parameter of the model with the regenerated parameter when the effluent water quality calculated according to the regenerated parameter based on the input variables measured in a second period is closer to the effluent water quality measured in the second period than the effluent water quality calculated according to the parameter before regeneration based on the input variables measured in the second period.

(13) Another aspect of the present invention provides the control method of aspect (11), wherein the manipulated value includes an airflow rate of aeration and a pumping amount indicating an amount of the influent water that is caused to flow into the process, wherein the influent water quality includes a turbidity, and wherein the effluent water quality includes at least one of total nitrogen concentration, total phosphorus concentration, or chemical oxygen demand.

(14) Another aspect of the present invention provides the control method of aspect (13), further comprising: adjusting, by the calibrator, a lag time corresponding to the effluent water quality for each of the input variables based on an increase or decrease in the pumping amount.

(15) Another aspect of the present invention provides the control method of aspect (11), further comprising: acquiring, by the calculator, the combination that minimizes total power cost in a predetermined period among the combinations satisfying the predetermined constraint condition based on information on power cost according to a time zone.

(16) Another aspect of the present invention provides the control method of aspect (15), further comprising: acquiring, by the calculator, the combination by using either an energy consumption or a CO₂ emission amount in addition to the power cost.

(17) Another aspect of the present invention provides the control method of aspect (11), wherein the constraint condition is a condition that the effluent water quality be better than a predetermined reference value.

(18) Another aspect of the present invention provides the control method of aspect (11), further comprising: acquiring, by the calculator, process data including a dissolved oxygen concentration indicating a concentration of oxygen dissolved in water being treated; increasing, by the calculator, an airflow rate of aeration when the dissolved oxygen concentration is below a predetermined range; and decreasing, by the calculator, the airflow rate when the dissolved oxygen concentration is above the predetermined range.

(19) Another aspect of the present invention provides the control method of aspect (18), further comprising: acquiring, by the calculator, process data including an ammonium nitrogen concentration of the water being treated; and increasing, by the calculator, an airflow rate of aeration when the ammonium nitrogen concentration exceeds a threshold and is rising.

(20) Another aspect of the present invention provides the control method of aspect (14), wherein the lag time indicates a time delay from a change of a value of the input variables to a time when the effluent water quality is affected by the change.

As used herein, the following directional terms “front, back, above, downward, right, left, vertical, horizontal, below, transverse, row and column” as well as any other similar directional terms refer to those instructions of a device equipped with the present invention. Accordingly, these terms, as utilized to describe the present invention should be interpreted relative to a device equipped with the present invention.

The term “configured” is used to describe a component, unit or part of a device includes hardware and/or software that is constructed and/or programmed to carry out the desired function.

Moreover, terms that are expressed as “means-plus function” in the claims should include any structure that can be utilized to carry out the function of that part of the present invention.

The term “unit” is used to describe a component, unit or part of a hardware and/or software that is constructed and/or programmed to carry out the desired function. Typical examples of the hardware may include, but are not limited to, a device and a circuit.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. A control system comprising:
a calculator configured to calculate, using a model of a process relating to water treatment, an output variable including an effluent water quality indicating a quality of effluent water flowing out of the process based on input variables including an influent water quality indicating a quality of influent water flowing into the process and a manipulated value for the process, the calculator being configured to acquire a combination satisfying a predetermined constraint condition among combinations of the manipulated value and the output variable;
a controller configured to control the process based on the manipulated value in the combination acquired by the calculator; and
a calibrator configured to regenerate a parameter representing a characteristic of the model at regular intervals and to replace the parameter of the model with the regenerated parameter when the effluent water quality calculated according to the regenerated parameter is closer to a measured value of the effluent water quality than the effluent water quality calculated according to the parameter before regeneration.

2. The control system according to claim 1,
wherein the calibrator is configured to:
regenerate the parameter based on the input variables and the output variable measured in a first period; and
replace the parameter of the model with the regenerated parameter when the effluent water quality calculated according to the regenerated parameter based on the input variables measured in a second period is closer to the effluent water quality measured in the second period than the effluent water quality calculated according to the parameter before regeneration based on the input variables measured in the second period.

3. The control system according to claim 1,
wherein the manipulated value includes an airflow rate of aeration and a pumping amount indicating an amount of the influent water that is caused to flow into the process,
wherein the influent water quality includes a turbidity, and
wherein the effluent water quality includes at least one of total nitrogen concentration, total phosphorus concentration, or chemical oxygen demand

4. The control system according to claim 3,
wherein the calibrator is configured to adjust a lag time corresponding to the effluent water quality for each of the input variables based on an increase or decrease in the pumping amount.

5. The control system according to claim 1,
wherein the calculator is configured to acquire the combination that minimizes total power cost in a predetermined period among the combinations satisfying the predetermined constraint condition based on information on power cost according to a time zone.

6. The control system according to claim 5,
wherein the calculator is configured to acquire the combination by using either an energy consumption or a CO₂ emission amount in addition to the power cost.

7. The control system according to claim 1,
wherein the constraint condition is a condition that the effluent water quality be better than a predetermined reference value.

8. The control system according to claim 1,
wherein the calculator is configured to:
acquire process data including a dissolved oxygen concentration indicating a concentration of oxygen dissolved in water being treated;
increase an airflow rate of aeration when the dissolved oxygen concentration is below a predetermined range; and
decrease the airflow rate when the dissolved oxygen concentration is above the predetermined range.

9. The control system according to claim 8,
wherein the calculator is configured to:
acquire process data including an ammonium nitrogen concentration of the water being treated; and
increase an airflow rate of aeration when the ammonium nitrogen concentration exceeds a threshold and is rising.

10. The control system according to claim 4,
wherein the lag time indicates a time delay from a change of a value of the input variables to a time when the effluent water quality is affected by the change.

11. A control method performed by a control system which comprises a calculator, a controller, and a calibrator, the control method comprising:
calculating, by the calculator, using a model of a process relating to water treatment, an output variable including an effluent water quality indicating a quality of effluent water flowing out of the process based on input variables including an influent water quality indicating a quality of influent water flowing into the process and a manipulated value for the process;
acquiring, by the calculator, a combination satisfying a predetermined constraint condition among combinations of the manipulated value and the output variable;
controlling, by the controller, the process based on the manipulated value in the combination acquired by the calculator;
regenerating, by the calibrator, a parameter representing a characteristic of the model at regular intervals; and
replacing, by the calibrator, the parameter of the model with the regenerated parameter when the effluent water quality calculated according to the regenerated parameter is closer to a measured value of the effluent water quality than the effluent water quality calculated according to the parameter before regeneration.

12. The control method according to claim 11, further comprising:
regenerating, by the calibrator, the parameter based on the input variables and the output variable measured in a first period; and
replacing, by the calibrator, the parameter of the model with the regenerated parameter when the effluent water quality calculated according to the regenerated parameter based on the input variables measured in a second period is closer to the effluent water quality measured in the second period than the effluent water quality calculated according to the parameter before regeneration based on the input variables measured in the second period.

13. The control method according to claim 11,
wherein the manipulated value includes an airflow rate of aeration and a pumping amount indicating an amount of the influent water that is caused to flow into the process,
wherein the influent water quality includes a turbidity, and
wherein the effluent water quality includes at least one of total nitrogen concentration, total phosphorus concentration, or chemical oxygen demand

14. The control method according to claim 13, further comprising:
adjusting, by the calibrator, a lag time corresponding to the effluent water quality for each of the input variables based on an increase or decrease in the pumping amount.

15. The control method according to claim 11, further comprising:
acquiring, by the calculator, the combination that minimizes total power cost in a predetermined period among the combinations satisfying the predetermined constraint condition based on information on power cost according to a time zone.

16. The control method according to claim 15, further comprising:
acquiring, by the calculator, the combination by using either an energy consumption or a CO₂ emission amount in addition to the power cost.

17. The control method according to claim 11,
wherein the constraint condition is a condition that the effluent water quality be better than a predetermined reference value.

18. The control method according to claim 11, further comprising:
acquiring, by the calculator, process data including a dissolved oxygen concentration indicating a concentration of oxygen dissolved in water being treated;
increasing, by the calculator, an airflow rate of aeration when the dissolved oxygen concentration is below a predetermined range; and
decreasing, by the calculator, the airflow rate when the dissolved oxygen concentration is above the predetermined range.

19. The control method according to claim 18, further comprising:
acquiring, by the calculator, process data including an ammonium nitrogen concentration of the water being treated; and
increasing, by the calculator, an airflow rate of aeration when the ammonium nitrogen concentration exceeds a threshold and is rising.

20. The control method according to claim 14,
wherein the lag time indicates a time delay from a change of a value of the input variables to a time when the effluent water quality is affected by the change.
